(19) United States
(12) Patent Application Publication
(10) Pub. No.: US 2015/0221405 A1
(43) Pub. Date: Aug. 6, 2015

(54) METHOD AND APPARATUS FOR GENERATING NEUTRONS FROM METALS UNDER THERMAL SHOCK

(71) Applicant: The Curators of the University of Missouri, Columbia, MO (US)

(72) Inventor: Mark Prelas, Columbia, MO (US)

(73) Assignee: The Curators of the University of Missouri, Columbia, MO (US)

(21) Appl. No.: 14/421,098

(22) PCT Filed: Aug. 12, 2013
(86) PCT No.: PCT/US13/54472

§ 371 Date: Feb. 11, 2015

Related U.S. Application Data
(60) Provisional application No. 61/682,578, filed on Aug. 13, 2012.

(51) Int. Cl. G21G 4/02; G21G 7/00; G21B 3/00

(52) U.S. Cl. CPC G21G 4/02; G21B 3/002; G21G 7/00; G21B 3/00

(57) ABSTRACT

A method and apparatus for generating neutrons by inducing hydride-forming metals infused with hydrogen isotopes to undergo rapid phase transitions. Such transitions are induced by exposing the metals to rapid temperature changes. The method includes placing the metals in a high-pressure reaction chamber, introducing a hydrogen isotope gas into the chamber to produce a metal hydride, reducing the temperature of the pressure chamber to maximize infusion of gas into metal, then quickly heating the reaction chamber, such that the temperature of the interior of the reaction chamber rapidly rises from a minimum temperature to a maximum temperature in an amount of time that is less than a thermal shock period. The temperatures and pressures are at such high levels that if two or more hydrogen isotope atoms are in the same void or defect within a crystalline lattice of the metal hydride, the atoms can react, resulting in neutron generation.

### RELATED APPLICATION

This non-provisional patent application claims priority benefit, with regard to all common subject matter, of earlier-filed U.S. Provisional Patent Application No. 61/682,578, filed Aug. 13, 2012, and entitled “PROCESS AND METHOD FOR GENERATING ENERGY FROM METALS UNDER THERMAL SHOCK.” The identified earlier-filed provisional patent application is hereby incorporated by reference in its entirety into the present application.

### FIELD

Embodiments of the present invention are directed to a method and apparatus for generating neutrons from metals under thermal shock. More particularly, embodiments provide for the generation of neutrons by forcing hydride forming metals infused with hydrogen isotopes to undergo rapid phase transitions due to thermal shock.

### BACKGROUND

The reaction of hydrogen isotopes is known to generate particles. In particular, light elements, such as hydrogen isotopes, may react to create new heavier elements or isotopes. The total mass of these new elements is less than the combined mass of the original constituent elements. The difference in mass is realized as an energy release that occurs during the reaction. Bringing two hydrogen isotopes, such as deuterium, close enough together so that they can react takes enormous amounts of temperature and pressure. Thus, net energy producing reactions are generally restricted to environments with extremely high temperatures and pressures, such as is present within the interior of stars.

The hydrogen isotope deuterium has a nucleus comprised of a proton and a neutron. Because protons have a positive charge and neutrons have a neutral charge, the net charge of a deuterium nucleus is positive. Thus, to create a reaction between two deuterium atoms, the repellant electromagnetic Coulomb force of the two protons must be overcome. Once the Coulomb force has been overcome, the strong nuclear force of the protons and neutrons can take over binding the two nuclei together and creating a new heavier element. However, the amount of pressure and temperature required to overcome the Coulomb force between two deuterium atoms is substantial (approximately 400 million Kelvin). With such a high temperature and pressure requirement, the amount of energy required to create the reaction is substantially higher than the energy output gained during the reaction process.

Several methods have previously been proposed to reduce the amount of energy input required to create reactions with deuterium or other hydrogen isotopes. For instance, magnetic confinement attempts to create reactions with hydrogen by utilizing magnetic and electrical fields to restrict and compress hydrogen plasma. Similarly, inertial confinement uses multiple laser beams to confine and squeeze hydrogen plasma together. In addition, several methods have been proposed that attempt to infuse hydride forming metals, such as palladium, with deuterium. In such a method, the absorption of deuterium by palladium causes the deuterium to compress, and in some circumstances, create a reaction.

### SUMMARY

Embodiments of the present invention include a method and apparatus for generating neutrons by inducing hydride forming metals infused with deuterium to undergo rapid phase transitions. Additional embodiments may include the use of other hydrogen isotope gases, like protium and tritium. Such transitions are induced by exposing the metal to rapid temperature changes, otherwise defined as thermal shock, wherein the rate of rapid temperature change is faster than the rate at which the gas diffuses out of voids or defects in crystal lattice sites within the metal. The method broadly includes the steps of placing the metal in a high-pressure reaction chamber of a reaction assembly; producing a metal hydride by introducing a hydrogen isotope gas into the chamber so that the gas begins infusing into the metal; exposing the reaction chamber to a cold environment, such that the temperature of the interior of the chamber reaches a minimum temperature, maximizing infusion of the gas and metal; and quickly exposing the reaction chamber to a hot environment, such that the temperature of the interior of the chamber rapidly rises from the minimum temperature to a maximum temperature in an amount of time that is less than a thermal shock period.

The generation of neutrons from the metal hydrides is understood to be caused by reactions of deuterium atoms that were infused within the metal. The reaction is caused by the intense pressures created within the crystalline structure of the hydrides as the crystalline lattices rapidly change phases due to the exposure of a rapid temperature increase. Normally, as pressure acting on the metal hydrides is increased, the deuterium will simply diffuse out of the metal. However, by quickly increasing the temperature of the metal hydrides, the pressure acting on the metal increases faster than the rate at which the deuterium can diffuse out. Thus, the deuterium becomes trapped within the voids or defects of the crystalline structure of the metal hydrides, generating a significant amount of pressure and temperature within the crystal. The temperatures and pressures are at such high levels that if two or more deuterium atoms are in the same void or defect, they create a reaction or otherwise “react.”

In Applicant's experiments, an approximate rate of 290,000 neutron counts per second were observed steadily over a five-minute period, wherein the neutron emissions started during the temperature shocking phase. Other runs during these experiments consistently resulted in raw neutron bursts during temperature shock phases. In Applicant's most recent experiments, a total of 1.5 million raw neutron counts were observed over a 10 minute period.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing features.

### BRIEF DESCRIPTION OF THE DRAWING FIGURES

Embodiments of the present invention are described in detail below with reference to the attached drawing figures, wherein:

FIG. 1 is a table listing of hydride-forming metals;

FIG. 2 is a side view of a temperature shock chamber constructed in accordance with embodiments of the invention;

FIG. 3 is a perspective view of a neutron counting chamber associated with the results testing phase of the temperature shock chamber of FIG. 2; and

FIG. 4 is a flow chart illustrating the steps involved in practicing an embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

### Hydride Forming Metals

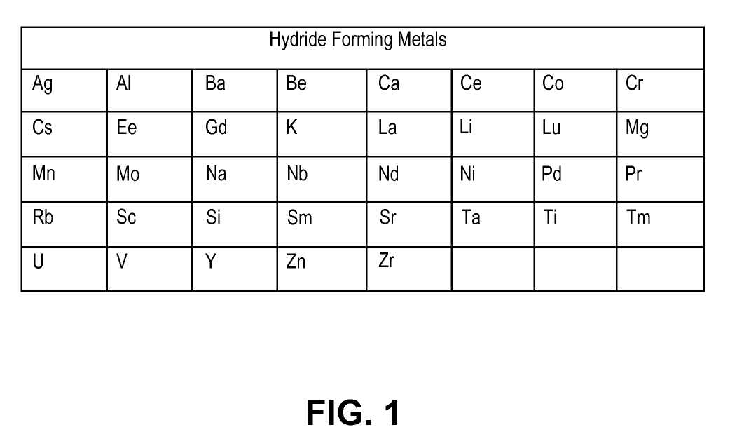

Embodiments of the present invention are directed to a method and apparatus for generating neutrons by thermally shocking hydride forming metals that have been infused with hydrogen isotopes. Some embodiments may provide for the use of any hydrogen isotope gas, such as deuterium, protium, and tritium. Other embodiments may also provide for the use of any of the hydride forming metals listed in FIG. 1. Hydride forming metals are defined as such because they readily combine with hydrogen isotopes to form hydride compounds. Although, the present invention contemplates the use of any of the hydride forming metals listed in FIG. 1, in certain embodiments, the metals palladium (Pd) and titanium (Ti) may be used. The elements Pd and Ti are specifically acknowledged because they are included among a group of hydride forming metals that are capable of absorbing very large amounts of hydrogen isotopes. For instance, it is estimated that at sufficiently low temperatures, Pd may absorb hydrogen isotopes in such amounts that the ratio of Pd atoms to hydrogen atoms approaches 1:1. In addition, it is estimated that Ti may absorb hydrogen in such amounts that the ratio of Ti atoms to hydrogen atoms approaches 10:7.

In addition to having the ability to absorb large amounts of hydrogen, it is also beneficial that the crystalline lattice structure of Pd and Ti transition through different lattice transformations when exposed to pressure and temperature changes. Phase diagrams illustrate how such changes take place. The phase diagrams of Pd and Ti, although distinctly different, are well known in the art. For instance, Pd retains its face-centered structure throughout the few phase changes that it experiences. Thus, the Pd crystalline lattice simply distorts from face-centered-cubic to face-centered-tetragonal upon changes in temperature and pressure. However, the Ti phase diagram is much more complex. The Ti crystalline lattice may transition between hexagonal-close-pack, face-centered-cubic, body-centered-cubic, and combinations thereof as the Ti is exposed to changing temperatures and pressures. Such lattice transitions may create pressure variations within the metals, and between certain phases changes, the lattice transitions will create a significant pressure increase.

In other embodiments, helium isotopes, such as He, Li, Be, or B may be incorporated into the crystalline lattice by implantation, or if they dissolve in the metal as part of the solution. In such an embodiment, implantation of helium isotope atoms can be facilitated through the use of micro bubbles, wherein the micro bubbles can be formed in the crystalline lattice through ion implantation by bombarding the lattice with helium, lithium, or boron ions, such that micro bubbles are formed, serving as a purposefully formed defect where during thermal shocking, gases can accumulate and compression and heating can occur. This particular embodiment refers to the implantation of atoms to form micro bubbles as disclosed in Applicant's patent application US 2009/0026879 A1, published Jan. 9, 2009, which is hereby incorporated by reference.

### Method for Generating Neutrons

Embodiments of the present invention include a method and apparatus for generating neutrons by inducing hydride forming metals infused with deuterium to undergo rapid phase transitions. Such transitions are induced by exposing the metals to rapid temperature changes, otherwise defined as thermal shock. The method broadly includes the steps of placing the metals in a high-pressure reaction chamber of a reaction assembly; producing a metal hydride by introducing a hydrogen isotope gas into the chamber while cooling the chamber until the metal absorbs the gas; and quickly raising the temperature of the reaction chamber, such that the temperature of the interior of the chamber rapidly rises from a minimum temperature to a maximum temperature in an amount of time that is less than a thermal shock period.

During a fast thermal shock, it is desired to cause a phase change in a metal deuteride at cryogenic temperatures that is maximally loaded with deuterium. In other embodiments, it is desired to cause a phase change in any metal hydride at cryogenic temperatures that are maximally loaded with a hydrogen isotope gas. The rate of temperature change in the metal hydride lattice is very rapid and can be calculated from the following Equation 1:

$${ρ}_{m} ( t ) {C}_{m} ( t ) \frac{\partial T}{\partial t} = ( ▽ \cdot {k}_{m} ( t ) ▽ T ) + Q ( t ) , \qquad Equation 1$$

where ρₘ is the time density of the metal deuteride (it is time dependent and a discontinuous function because the metal deuteride can instantaneously change density as it phase transitions), Cₘ is the specific heat capacity of the metal deuteride (it too is time dependent and a discontinuous function because the metal deuteride can instantaneously change density as it phase transitions), km is the conductivity (it too is time dependent and a discontinuous function because the metal deuteride can instantaneously change density as it phase transitions), T is temperature, t is time, V is the vector differential operator (or “del” operator) and Q(t) is the time dependent heat source. In other embodiments, the above equation generally applies to any metal hydride.

The metal may be selected from metals with varying porosity; however, in certain embodiments, a highly-porous metal sponge may be used. The size of the metal may vary between 1/8th inch metal chips to powder-like granules, wherein the granules are comprised of crystalline particles with diameters approximately nanometers to micrometer in scale. In certain embodiments of the present invention, the metal's absorption of the hydrogen isotope may be maximized by varying the sizes of the metal sponge pieces. In certain embodiments, a powder form may be used. In other embodiments, the hydrogen isotopes may primarily be absorbed in the outer layers of the metal, such that it may be beneficial to increase the surface area of the metal by breaking it up into very small pieces. Once the metal has been reduced to the appropriate size, the metal is agitated to remove any oxide or nitride coating that may have formed on the metal's exterior surface. In certain embodiments, the agitation can be performed by placing the metal sponges in a jar and shaking the jar in a shaker, such as a paint shaker, for several minutes. Additional embodiments may include the use of other agitation methods, such as acoustic agitators or extreme temperature variation in conjunction with a vacuum.

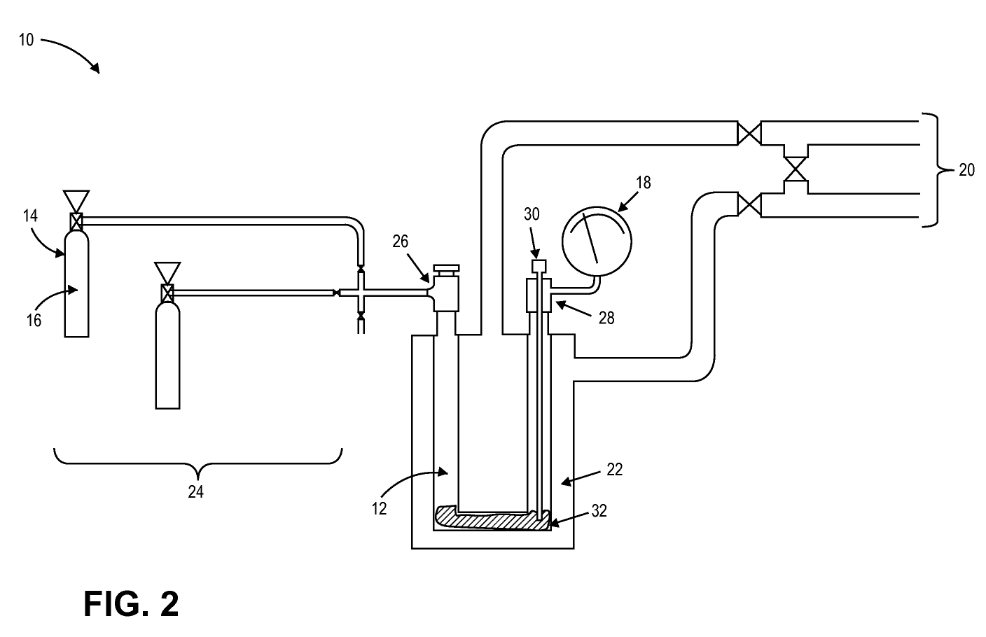

After the metal has been de-oxidized, the metal is placed in the high-pressure reaction chamber of the reactor assembly. The reaction chamber is brought under a high vacuum to remove any impurities that may have been introduced to the chamber and/or the metal. An embodiment of the reactor assembly 10 used to perform embodiments of the present invention is illustrated in FIG. 2 and is broadly comprised of a high-pressure reaction chamber 12; a deuterium gas source 14 that is attached to the reaction chamber 12 and is operable to introduce deuterium 16 into the chamber 12; pressure and temperature sensors 18 positioned within the chamber 12 operable to measure the pressure inside the chamber and temperature inside and outside the chamber 12; and a hot water application system 20 that is operable to provide a high temperature water flow around the chamber 12, such that the temperature inside the chamber 12 can be quickly elevated.

The reaction chamber 12 is comprised of U-shaped copper tubing that is surrounded by an outer chamber 22 made from 304 stainless steel. A loading end of the reaction chamber 12 is connected to a gas manifold 24 and includes a T joint 26 that may be opened to allow for the metal to be placed within the reaction chamber 12. A measurement end of the reaction chamber 12 includes a T joint 28 in which a pressure gauge 18 and thermocouple 30 are inserted. The deuterium source 14 is connected to the reaction chamber 12 via the T joint 26 of the loading end. The high temperature application system 20 is connected to the outer chamber 22 of the reactor, such that a hot liquid can be introduced to the reactor and heat can be transmitted, via convection, to the reaction chamber 12 and the metal 32 within the chamber. A cold temperature application system (not shown) may also be included, whereby the reactor assembly 10 may be placed within a cold temperature bath. Depending on the temperature required, the cold temperature application system may include an open chamber (the “vat”) containing a bath of liquid nitrogen. In another embodiment, liquid helium may be used. Different structural versions of the reactor assembly 10 may alternatively be used to perform the process and method of the present invention. For instance, the high temperature application system 20 may be combined with the cold temperature application system, such that the hot and cold fluids may be alternatingly and quickly applied to the reactor assembly. The ability to quickly alternate the application of hot and cold fluids may provide for the metal to be thermally shocked at a substantially quicker rate. For example, in one embodiment of the reactor assembly, a variable temperature application system would able to pump liquid nitrogen to the outer chamber 22 of the reactor for purposes of loading the metal hydride, then quickly adapting to pumping boiling water to the outer chamber 22 of the reactor for purposes of thermally shocking the metal hydride. Other embodiments could pump a hot liquid to the outer chamber 22 to heat the metal hydride, then pump a cold fluid to the outer chamber 22 to lower the temperature at various temperature intervals for purposes of expediting the maximum infusion of gas into the metal, then quickly adapting to pumping a hot fluid capable of raising the temperature of the metal hydride for purposes of thermally shocking the metal hydride.

Once the metal 32 has been placed within the reaction chamber 12, the reactor assembly 10 is placed in the liquid nitrogen bath to cool the reaction chamber 12 and the metal 32 down to a minimum temperature obtainable in the liquid nitrogen bath. The freezing point of liquid nitrogen being −210 C and the boiling point of liquid nitrogen being −196 C. In Applicant's experiments, the liquid nitrogen bath was used to cool the reaction chamber and the metal down to a minimum temperature of −190 C and a minimum temperature of −186 C. In embodiments of the present invention, the minimum temperature may be about −210 C to −190 C and about −210 C to about −186 C. In another embodiment, liquid hydrogen may be used to obtain a minimum temperature of about 14K, the freezing point of liquid hydrogen. After the reaction chamber 12 has reached the minimum temperature, the deuterium 16 is introduced to the reaction chamber via the deuterium source 14 until the pressure within the reaction chamber 12 reaches an absorption pressure. In certain embodiments, such absorption pressure is approximately 345 kPa; however, the pressure necessary for the metals 32 to absorb the deuterium 16 may depend on variety of factors, such as metal size, metal porosity, minimum temperature, etc. The absorption pressure can be calculated depending on the deuterium atom source rate flowing into the volume and the diffusion rate of the deuterium atoms out of the volume as described in Equation 2 below. The absorption pressure is maintained for an absorption period, wherein the absorption period may range from several minutes to several hours or days. Upon the expiration of the absorption period, the metals have maximally absorbed the deuterium with respect to the given conditions, such that the metals are saturated metal hydrides.

The ideal set up of this “loading” phase is to obtain maximum infusion of the gas by the metal. The loading ratio, X, in this particular embodiment is the atomic ratio between deuterium and metal in the compound, and in most embodiments, is a high-loading ratio (approximately 0.67). Obtaining high loading ratios is difficult, however, when working at low temperatures because the diffusion coefficient of deuterium in metal hydride decreases, and reaching equilibrium takes more time. The value of X at equilibrium is a function of pressure and temperature. Therefore, maximum infusion can be obtained by decreasing the temperature of the metal and infusing the gas in a high-pressure environment over time. In this particular embodiment, maximum infusion can be judged by looking at exothermic reactions on the metal hydride. Exothermic reactions are measured in this embodiment by measuring the pressure of gas in the reaction chamber and measuring the temperature of the metal hydride. If the deuterium pressure within the reaction chamber is dropping during cooling at the minimum temperature, the metal hydride is still absorbing the gas. Further, if the temperature of the metal hydride is increasing during the cooling phase at the minimum temperature, it is inferred that heat is generated as a result of exothermic reactions occurring on the surface of the metal hydride. Once the temperature of the metal hydride reaches the minimum temperature, and the pressure of the reaction chamber stabilizes, in can be concluded that the exothermic reactions have subsided, and no more gas is being infused into the metal hydride, thus having reached maximum infusion.

In one particular embodiment, maximum infusion can be expedited by infusing the gas in a high-pressure environment at the maximum temperature and waiting until exothermic reactions subside, then dropping the temperature of the reaction chamber to 50 C and waiting until exothermic reactions subside, then dropping the temperature of the reaction chamber to 15 C and waiting until exothermic reactions subside, then finally dropping the temperature down to the minimum temperature until exothermic reactions subside so that maximum infusion is obtained. Other embodiments may exclude the heating step altogether, or select from any combination of temperatures and number of intervals for heating and cooling to expedite maximum infusion.

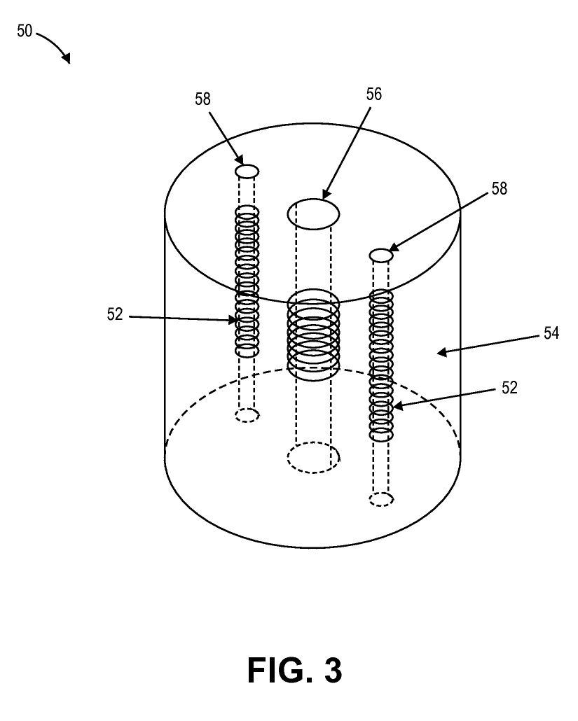

The reactor assembly 10 in FIG. 2 may then be removed from the cold temperature vat and placed in an embodiment of a neutron counting chamber 50 as illustrated in FIG. 3. The neutron counting chamber 50 includes one or more neutron detectors 52 and is operable to count the number of neutrons that are emitted from the metal hydrides. The neutron counting chamber 50 illustrated in FIG. 3 is comprised of a block of paraffin 54 with a center hole 56 that accommodates the temperature shock apparatus 10 in FIG. 2. In addition, two He-3 detectors 52 are located in holes 58 on either side of the temperature shock chamber when placed in the center hole 56.

Once the reactor assembly 10 in FIG. 2 has been placed within the neutron counting chamber 50 in FIG. 3, the high temperature application system 20 in FIG. 2 may be initiated such that hot fluid is introduced to the outer chamber 20 of the reactor assembly 10. The temperature and flow rate of the hot fluid is significant enough that the temperature of the reaction chamber 12 and the metal hydride 32 can rise to the maximum temperature, defined by the maximum temperature of the heat source, within the shock period.

In certain embodiments, the maximum temperature may be greater than the ambient temperature. In another embodiment, the maximum temperature may be in the range between about 20 C and about 100 C. For example, in the disclosed embodiment, boiling water was used to achieve a maximum temperature of about 100 C. In other embodiments, the maximum temperature may be in the range of about 100 C to about the boiling point of the hydride forming metal. In this particular embodiment, the maximum temperature may be in the range of about 100 C to about 3287 C, the boiling point of titanium. Embodiments that require extremely high maximum temperatures may encompass the use of high-energy beams of lasers, electrons, or ions, as the heat source. For example, some embodiments may encompass the use of high-energy lasers that can easily heat metals far hotter than 1000 C. Other embodiments may use lasers hot enough to routinely vaporize steel at 3000 C, or tungsten at 5550 C, and approaching the surface temperature of the Sun at 5800 C.

As temperature is rapidly increased, the crystalline lattices in the metal hydride will experience phase changes and therefore the deuterium will begin to diffuse out. The diffusion rate of the deuterium is dependent on the temperature of the metal hydride, as explained in Equation 2 below. The goal is to increase temperature at a rate that is faster than the rate at which the deuterium can diffuse out of the crystalline lattice. In the disclosed embodiment, water from 20-100 C is used to heat the reaction chamber while the expected heating rate was approximately 9.3 C/sec. The use of water can provide a maximum temperature at its boiling point of 100 C. Titanium in the reaction chamber along with the gaseous atmosphere could have influenced a higher heating rate because some conduction through the titanium may have occurred. In other embodiments, the heating rate can be from about 9 C/sec to greater than about 10000 C/sec. In all embodiments, the heating rate is a rate faster than the rate at which the gas can diffuse out of the lattice.

In certain embodiments, the shock period may be approximately 20 seconds; however, other embodiments may include a different shock period, as long as the temperature increase forces the metal hydride 32 to undergo rapid phase changes. As the metal hydride 32 undergoes the rapid phase changes, deuterium elements are found to react, thus generating a burst of neutron emissions. The reaction rate may in the form:

RR_{F}∝ρ_{D}f(T),

where ρ_{D} is the density of deuterium and f(T) is the function of temperature. If V is constant in Ideal gas law (PV=nRT), both P and T will increase during thermal shocking. When T increases, the reaction rate increases as well. Thus, thermal shocking will make the reaction rate increase.

As the temperature of the metal changes and a phase change occurs, this phase transition takes place over a very short time period, tₚₕ (where the subscript ph relates to the change from one phase to another phase). During the phase transition, deuterium atoms come out of solution rapidly. The deuterium atoms are either trapped in interstitial spaces in a crystal matrix or in defects. As the phase transition occurs, deuterium atoms come out of solution and begin to collect. The rate of collection is related to the change of deuterium density (ρ) in the defect (potentially the same model would apply to the interstitial void in the crystal lattice). The density of deuterium atoms in the volume will change and that change will be dependent upon the deuterium atom source rate flowing into the volume and the diffusion rate of the deuterium atoms out of the volume.

$$\frac{\partial ρ ( r , t )}{\partial t} = ▽ \cdot [ D ( ρ , r ) ▽ ρ ( r , t ) ] + {\dot{ρ}}_{s} , \qquad Equation 2$$

where the deuterium density, ρ, is dependent upon the position vector (r) and time, D(ρ,r) is the diffusion coefficient, and \dot{ρ}ₛ is (deuterium atom flow rate into volume due to change of phase)/ΔV.

The volume remains constant as deuterium atoms flow into the volume, but the pressure increases. As pressure increases, temperature will increase. Using Van der Waals equation of state to describe the relationship between pressure and temperature:

$$[ P + a \frac{{N}^{2}}{{V}^{2}} ] ( V - Nb ) = NRT , \qquad Equation 3$$

where N(t) is the time dependent number of deuterium atoms, a is an empirical constant, b is an empirical constant, R is the Universal gas constant and T is temperature. Dividing Equation 3 by ΔV and defining ρ(t) as the time dependent deuterium density=N(t)/ΔV, Van der Waals equation can be rewritten as:

[P+αρ²](1−ρb)=ρRT. Equation 4

As more atoms flow into the volume ΔV, pressure and temperature increases. The compression of deuterium gas is complicated since the intermolecular repulsion forces are strong.

In an additional embodiment of the present invention, the rapid thermal shocking of the metal hydride may be obtained by exposing the metal to an intense laser energy source. For instance, a high-energy beam of laser light, electrons, or ions may be directed at the metal hydride target. As the beam impacts the outer layer of the metal, the heat and pressure are directed inward, thus compressing the metal and generating temperatures and pressures high enough to create a reaction. In addition, such an embodiment may create thermal shock waves that travel through the metal with enough energy to cause the hydrogen isotopes to create a reaction. In other embodiments, any form of heat source can be used to heat the metal hydride, as long as the heating rate is greater than the rate at which the hydrogen isotope gas can diffuse out of the void or defect.

As noted above, the generation of neutrons from the metal hydrides is caused by the reaction of deuterium atoms that were infused within the metal. The reaction is caused by the intense pressures created within the crystalline structure of the hydrides as the crystalline lattices rapidly change phases due to the exposure of a rapid temperature increase. The interstitial void spaces of the crystalline lattice are generally on the order of approximately 4.2 Angstrom, and defects in the lattice may be on the order of 10 Angstrom. By infusing the metal at the minimum temperature, the amount of deuterium absorbed by the metal is maximized. In such an infusion, the deuterium can group together in clusters and reside within voids or defects in the metal's crystalline structure. Normally, as pressure acting on the metal hydrides is increased, the deuterium will simply diffuse out of the metal. However, by quickly increasing the temperature of the metal hydrides, the pressure acting on the metal increases faster than the rate at which the deuterium can diffuse out. Thus, the deuterium becomes trapped within the voids or defects, generating a significant amount of pressures and temperatures within the crystal. The temperatures and pressures are at such high levels that if two or more deuterium atoms are in the same void or defect, a reaction can occur. For instance, it is estimated that deuterium infused titanium undergoing the above-stated thermal shock process will generate pressures in excess of 200,000 psi within its internal crystalline lattice structure.

Upon initiation of the reactions within the metal hydride, the generated energy obtained from the reactions may be significant. The normal channels for deuterium (D) reactions may be of the form:

D+D→n+³He+3.5 MeV

D+D→p+T+4.04 MeV

The energy values listed in electron volts (eV) are realized as heat energy caused by high energy particles or ions that are released during the reaction. In addition, the other particles (neutrons, protons, tritium, and helium) may also be realized as heat energy, as they may interact with the crystalline lattice of the metal. As can be appreciated, the energy generation produced by each individual reaction is relatively small. However, the ability for the metal to absorb significant amounts of deuterium provides for the reaction of a correspondingly significant amount of deuterium atoms.

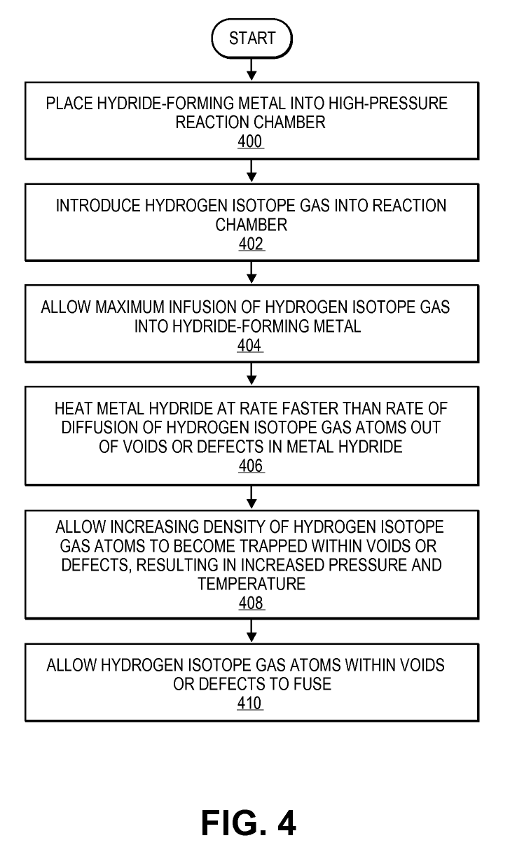

In summary, the steps required in order to practice the disclosed embodiment of this invention are shown in FIG. 4. As shown in Step 500, a hydride-forming metal is placed into a high-pressure reaction chamber. A hydrogen isotope gas is then introduced into the reaction chamber using a gas supply, per Step 502. At Step 504, the hydride-forming metal is then cooled so that the hydrogen isotope gas is maximally infused with the hydride-forming metal, resulting in a metal hydride. The metal is then heated at a rate faster than the rate hydrogen isotope gas atoms diffuse out of any voids or defects in the metal hydride, as set forth in Step 506. The hydrogen isotope gas atoms become trapped within the voids or defects of the metal hydride, and the density of such trapped atoms is allowed to increase, which results in an increase in pressure and temperature, as set forth in Step 508. At Step 510, the hydrogen isotope gas atoms within the voids or defects are then allowed to create a reaction.

Although the invention has been described with reference to the preferred embodiments illustrated in the attached drawings, it is noted that equivalents may be employed and substitutions made herein without departing from the scope of the invention as recited in the claims.

Having thus described a preferred embodiment of the invention, what is claimed as new and desired to be protected by Letters Patent includes the following:

1. A method for generating neutrons comprising the steps of:
placing a hydride-forming metal into a high-pressure reaction chamber;
introducing a hydrogen isotope gas into the reaction chamber using a gas supply;
allowing a maximum infusion of the hydrogen isotope gas into the hydride-forming metal by cooling the hydride-forming metal to a temperature wherein the infusion creates a metal hydride;
heating the metal hydride at a rate faster than a rate of diffusion of a plurality of hydrogen isotope gas atoms out of at least one void or at least one defect in the metal hydride;
allowing an increasing density of hydrogen isotope gas atoms to become trapped within the void or defect of the metal hydride, resulting in an increase of pressure and temperature within the void or defect; and
allowing the hydrogen isotope gas atoms within the void or defect to create a reaction.

2. The method of claim 1, wherein the maximum infusion of hydrogen isotope gas into the hydride-forming metal step further comprises the steps of:
heating the hydride-forming metal to at least one temperature between about ambient temperature and a maximum temperature and waiting until exothermic reactions subside; and
cooling the hydride-forming metal to at least one temperature between the maximum temperature and a minimum temperature and waiting until exothermic reactions subside.

3. The method of claim 1,
wherein the heating step is accomplished by directing a heat source at the gas-infused metal within the chamber,
wherein the heat source is selected from the group consisting of: a high-energy beam of laser-light, a high-energy beam of electrons, and a high-energy beam of ions.

4. The method of claim 2,
wherein the heating step is accomplished by directing a heat source at the gas- infused metal within the chamber,
wherein the heat source is selected from the group consisting of: a high-energy beam of laser-light, a high-energy beam of electrons, and a high-energy beam of ions.

5. The method of claim 1,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction chamber.

6. The method of claim 2,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction chamber.

7. A method for generating neutrons comprising the steps of:
placing a hydride-forming metal into a high-pressure reaction chamber;
introducing a hydrogen isotope gas into the reaction chamber using a gas supply;
allowing a maximum infusion of the hydrogen isotope gas into the hydride-forming metal by cooling the hydride-forming metal to a minimum temperature of about −210 C to about −186 C, wherein the infusion creates a metal hydride;
heating the metal hydride at a rate faster than a rate of diffusion of a plurality of hydrogen isotope gas atoms out of at least one void or at least one defect in the metal hydride;
allowing an increasing density of hydrogen isotope gas atoms to become trapped within the void or defect of the metal hydride, resulting in an increase of pressure and temperature within the void or defect; and
allowing the hydrogen isotope gas atoms within the void or defect to create a reaction.

8. The method of claim 7, wherein the maximum infusion of hydrogen isotope gas into the hydride-forming metal step further comprises the steps of:
heating the hydride-forming metal to at least one temperature between about ambient temperature and a maximum temperature and waiting until exothermic reactions subside; and
cooling the hydride-forming metal to at least one temperature between the maximum temperature and the minimum temperature and waiting until exothermic reactions subside.

9. The method of claim 7,
wherein the heating step is accomplished by directing a heat source at the gas-infused metal within the chamber,
wherein the heat source is selected from the group consisting of: a high-energy beam of laser-light, a high-energy beam of electrons, and a high-energy beam of ions.

10. The method of claim 8,
wherein the heating step is accomplished by directing a heat source at the gas-infused metal within the chamber,
wherein the heat source is selected from the group consisting of: a high-energy beam of laser-light, a high-energy beam of electrons, and a high-energy beam of ions.

11. The method of claim 7,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction chamber.

12. The method of claim 8,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction chamber.

13. A method for generating neutrons comprising the steps of:
placing a hydride-forming metal into a high-pressure reaction chamber;
introducing a hydrogen isotope gas into the reaction chamber using a gas supply;
allowing a maximum infusion of the hydrogen isotope gas into the hydride-forming metal by cooling the hydride-forming metal to a minimum temperature of about −210 C to about −190 C, wherein the infusion creates a metal hydride;
heating the metal hydride at a rate faster than a rate of diffusion of a plurality of hydrogen isotope gas atoms out of at least one void or at least one defect in the metal hydride;
allowing an increasing density of hydrogen isotope gas atoms to become trapped within the void or defect of the metal hydride, resulting in an increase of pressure and temperature within the void or defect; and
allowing the hydrogen isotope gas atoms within the void or defect to create a reaction.

14. The method of claim 13, wherein the maximum infusion of hydrogen isotope gas into the hydride-forming metal step further comprises the steps of:
heating the hydride-forming metal to at least one temperature between about ambient temperature and a maximum temperature and waiting until exothermic reactions subside; and
cooling the hydride-forming metal to at least one temperature between the maximum temperature and the minimum temperature and waiting until exothermic reactions subside.

15. The method of claim 13,
wherein the heating step is accomplished by directing a heat source at the gas-infused metal within the chamber,
wherein the heat source selected from the group consisting of: a high-energy beam of laser-light, a high-energy beam of electrons, and a high-energy beam of ions.

16. The method of claim 14,
wherein the heating step is accomplished by directing a heat source at the gas-infused metal within the chamber,
wherein the heat source selected from the group consisting of: a high-energy beam of laser-light, a high-energy beam of electrons, and a high-energy beam of ions.

17. The method of claim 13,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction.

18. The method of claim 14,
wherein the steps of cooling and heating are performed by an apparatus comprising:
a cold temperature application system, and
a hot temperature application system,
wherein the cold temperature application system and the hot temperature application system are combined such that cold and hot temperatures may be alternatingly and quickly applied to the reaction chamber.
